(19) United States
(12) Patent Application Publication
(10) Pub. No.: US 2009/0164284 A1
(43) Pub. Date: Jun. 25, 2009

(54) CUSTOMER SHOPPING PATTERN ANALYSIS APPARATUS, METHOD AND PROGRAM

(75) Inventors: Takashi KOISO, Kanagawa (JP); Masaki NARAHASHI, Tokyo (JP); Masami TAKAHATA, Tokyo (JP)

Correspondence Address: HARNESS, DICKEY & PIERCE, P.L.C., P.O. BOX 828, BLOOMFIELD HILLS, MI, 48303, US

(73) Assignee: TOSHIBA TEC KABUSHIKI KAISHA, Tokyo (JP)

(21) Appl. No.: 12/393,510

(22) Filed: Feb. 26, 2009

Related U.S. Application Data
(63) Continuation of application No. PCT/JP2008/064404, filed on Aug. 11, 2008.

(30) Foreign Application Priority Data
Aug. 13, 2007 (JP) 2007-210934

(51) Int. Cl. G06Q 10/00

(52) U.S. Cl. 705/7

(57) ABSTRACT

A customer shopping pattern analysis apparatus includes a correlating information storage section, and a sub-area information storage section. Upon receiving specifications of a particular sub-area as analysis conditions, flow line data of customers who passed through the particular sub-area are extracted based on information specifying the particular sub-area in the sub-area information storage section and based on the flow line data of each of the customers. In addition, transaction data correlated with the flow line data extracted is specified with reference to data in the correlating information storage section. Then, information about correlations between the flow line data extracted and the transaction data is created. From the thus created information, the apparatus analyzes the shopping patterns of the customers in the shop.

### CROSS REFERENCE TO RELATED APPLICATIONS

This is a Continuation Application of PCT Application No. PCT/JP2008/064404, filed Aug. 11, 2008, which was published under PCT Article 21(2) in Japanese.

This application is based upon and claims the benefit of priority from prior Japanese Patent Application No. 2007-210934, filed Aug. 13, 2007, the entire contents of which are incorporated herein by reference.

### BACKGROUND OF THE INVENTION

1. Field of the Invention

The present invention relates to an apparatus and method for analyzing the shopping pattern of a customer based on data about the customer's flow line and the customer's transaction data, and relates to a computer-readable program that enables a computer to function as a customer shopping pattern analysis apparatus.

2. Description of the Related Art

Systems for analyzing the shopping pattern of customers in shops have been disclosed in patent documents such as Japanese Patent Application Laid-Open Nos. 2005-309951 and 2006-350751.

The technologies described in both the patent documents analyze merchandise purchased by each customer and the route of the customer through the shop. This enables a rough analysis of, for example, where a customer who purchased a certain item of merchandise in a shop passed within the shop. However, the relationship between the customer who enters a specific area of the shop and merchandise placed in the specific area cannot be analyzed in detail.

### BRIEF SUMMARY OF THE INVENTION

An object of the present invention is to provide technology for analyzing a customer's shopping pattern that enables the relationship between the customer who enters a specific area of the shop and merchandise placed in that area to be analyzed easily in detail.

The present invention analyzes the shopping pattern of a customer in a shop based on a flow line database storing flow line data, which is data about the traces of customers' movements in a shop, and a transaction database, which stores transaction data.

### BRIEF DESCRIPTION OF THE SEVERAL VIEWS OF THE DRAWINGS

FIG. 1 is a block diagram of the configuration of a system according to one embodiment of the present invention.

FIG. 2 is an example of the record configuration of transaction data.

FIG. 3 is an example of the record configuration of flow line data.

FIG. 4 is a main memory table formed in the data storage section in a customer shopping pattern analysis apparatus.

FIG. 5 is an example of the data of a transaction ID list table shown in FIG. 4

FIG. 6 is an example of the data of a flow line ID list table shown in FIG. 4.

FIG. 7 is an example of the data of a correlating table shown in FIG. 4.

FIG. 8 is an example of the data of a sub-area setting table in FIG. 4.

FIG. 9 is an example of the layout of a shop area.

FIG. 10 is an example of the division of the shop area shown in FIG. 9.

FIG. 11 is the first half of a flowchart of the main control procedure of a control section when a customer shopping pattern analysis apparatus runs a customer shopping pattern analysis program.

FIG. 12 is the second half of a flowchart of the main control procedure of a control section when a customer shopping pattern analysis apparatus runs a customer shopping pattern analysis program.

FIG. 13 is a data structure of an output list table created by the customer shopping pattern analysis apparatus.

FIG. 14 is a view illustrating a method for calculating customer shopping pattern data.

FIG. 15 is a diagram showing the staying times of sub-areas visited by three customers who stayed in a specified sub-area and purchased a specified item of merchandise.

FIG. 16 is a diagram showing the longest staying times of sub-areas visited by three customers who stayed in a specified sub-area and purchased a specified item of merchandise.

FIG. 17 is a graph showing the longest staying times according to the sub-areas in the diagram shown in FIG. 16.

FIG. 18 is a diagram showing the result of counting entrance sub-areas and exit sub-areas used by customers who stayed in a specified sub-area.

FIG. 19 is a flowchart illustrating an example of an algorithm for finding correlations between the entrance rate and exit rates.

FIG. 20A shows an example of a flow line when a customer is stopping and that when a customer is walking slowly.

FIG. 20B shows an example of a flow line when a customer is walking slowly.

FIG. 21 is a view illustrating an angle to determine whether a customer is walking slowly.

### DETAILED DESCRIPTION OF THE INVENTION

Hereinafter, preferred embodiments according to the present invention will be described with reference to the accompanying drawings.

The present embodiments are described using as an example a case where the present invention is applied in a customer shopping pattern analysis apparatus that analyzes the shopping pattern of a customer based on the flow line data of customers moving in a shop together with the customer's transaction data. The flow line data refers to the route of each of the customers in the shop. The transaction data refers to, for example, the content of transactions, such as merchandise purchased by the customers, and the prices of the merchandise.

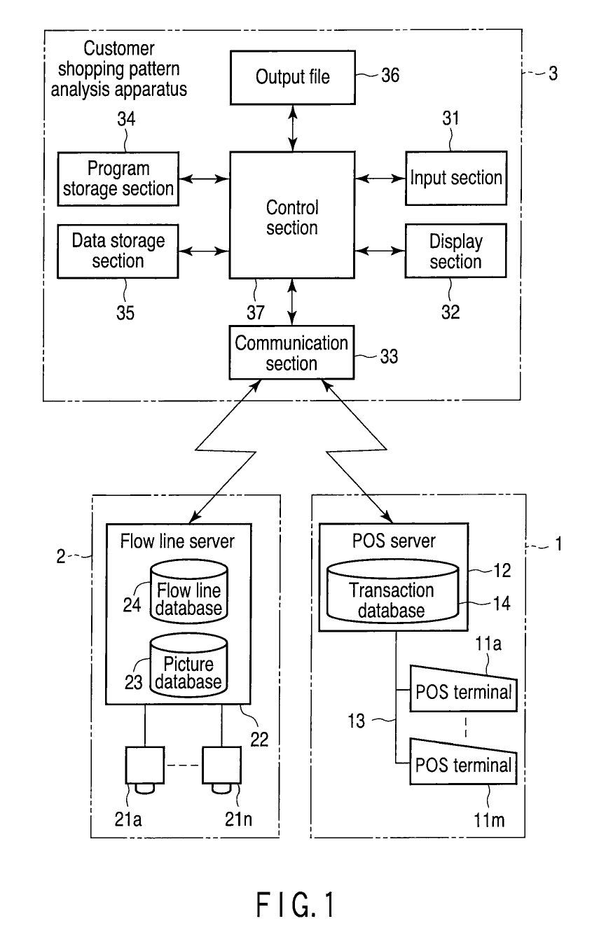

FIG. 1 shows the configuration of a system in accordance with the present embodiment. The system includes: a sales management system 1 for creating and managing transaction data; a flow line management system 2 for creating and managing the flow line data; and a customer shopping pattern analysis apparatus 3.

The sales management system 1 has: a number of (m) POS terminals 11 (11a to 11m) installed at checkout points in a shop; and a POS server 12 functioning as a host machine for them. The POS server 12 and each of the POS terminals 11 are connected by means of a communication line 13 such as a local area network (LAN). Such a sales management system 1 is generally called a point-of-sales (POS) system.

Each of the POS terminals 11 functions as a settlement terminal. That is, each POS terminal 11 processes the sales data of merchandise purchased by customers and settles transactions between the customers and the shop. Each POS terminal 11 creates transaction data each time a transaction is settled. The transaction data created by each POS terminal 11 is transmitted to the POS server 12 through the communication line 13. The POS server 12 stores the transaction data transmitted from each POS terminal 11 in a transaction database 14.

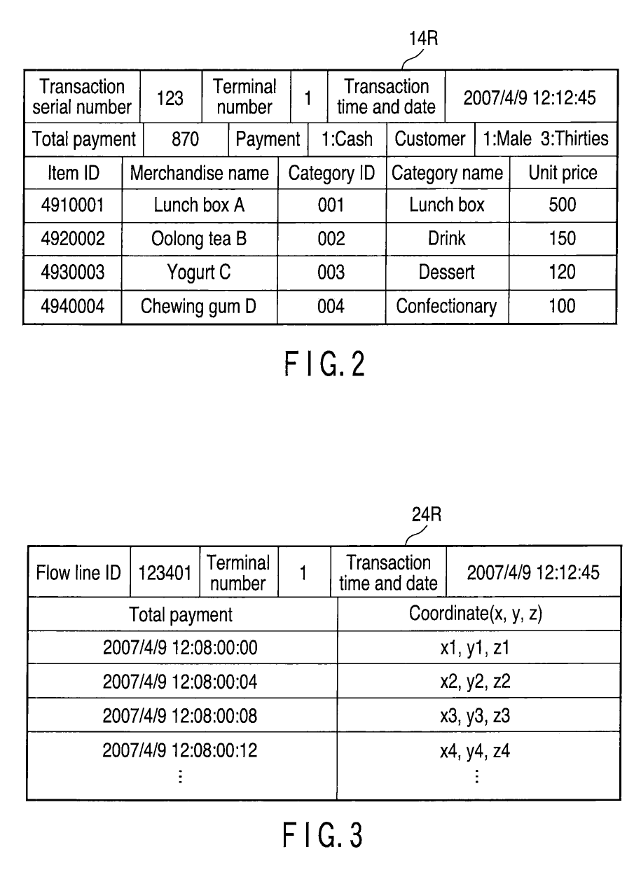

FIG. 2 shows an example of the configuration of a record of transaction data stored in the transaction database 14. As shown in FIG. 2, a record 14R of the transaction data includes information on the transaction serial number, terminal number, transaction time and date, total payment, payment section, quality of customer's, and merchandise purchased.

The terminal number is a number specific to a terminal assigned to the POS terminal 11 that has created the transaction data. The transaction serial number is a number specific to a transaction and is issued each time the POS terminal 11 processes a transaction.

The transaction time and date is the time and date when a transaction is initiated in a POS terminal 11, which incorporates a clock IC. Upon input of the merchandise data for a customer's first purchase, the time and date measured by the clock IC is set as the transaction time and date in the transaction data. Incidentally, the transaction time and date is not necessarily the point in time that the transaction is initiated but may be the point in time that the transaction is settled. Specifically, it may be when a check out key, such as a deposit/cash key, is operated.

Each item of transaction data can be identified uniquely by a combination of a terminal number, a transaction time and date, and a transaction serial number. That is, a datum composed of a terminal number, a transaction time and date, and a transaction serial number, functions as an ID for each transaction datum. The data serving as ID will hereinafter be called “transaction ID.”

Merchandise purchased data refers to data about an item of merchandise purchased by a customer in a transaction specified by a corresponding transaction ID. Each item of merchandise has merchandise purchased data that include item data such as an item ID, item of merchandise name, category ID, category name, and unit price. The item ID is a code for identifying an item of merchandise specified by the name of the merchandise. Examples of this code are a product code, price look-up (PLU) code, or European Article Number (EAN). The category ID is a code for identifying the category of merchandise specified by category name. Examples of category ID are the section code and the group code.

The flow line management system 2 includes a number of cameras 21 (21a to 21n) and a flow line server 22. The cameras 21 photograph customers moving in a shop. The flow line server 22 creates flow line data for each customer from pictures photographed by cameras 21. The flow line data includes time and date per unit time and the positional coordinates of each customer at the time. The positional coordinates have a three-dimensional point of origin (0, 0, 0) assigned to a predetermined location in a shop, and the degree of three-dimensional displacement relative to the point of origin is expressed by three-dimensional coordinates (x, y, z).

The flow line server 22 has the functions (i) to (vi) described below.

(i) The function of inputting the data from pictures photographed by each camera 21 and writing the picture data into the picture database 23 together with the times and dates acquired by the incorporated clock IC.

(ii) The function of extracting a person (i.e., customer), which is a moving body, as a target through image-processing of the picture data recorded in the picture database 23.

(iii) The function of tracing the movement of each customer and creating, for the customer, flow line data indicating the route of the customer from when the customer enters the shop to when he or she exits it.

(iv) The function of adding a flow line ID to the flow line data of each customer as flow line identifying information that specifies the flow line data.

(v) The function of adding, to the flow line data of the customer, the transaction time and date when the customer settled a transaction, and the terminal number of the POS terminal 11 installed at a checkout point where the customer settled the transaction.

(vi) The function of writing, in the flow line database 24, the flow line data of each customer to which the flow line ID, the transaction time and date and the terminal number have been added.

Connected to the flow line server 22 are a display section such as a liquid crystal display, and input sections such as a keyboard and a mouse. The flow line server 22 can show, on a display section, pictures taken by each camera and flow lines formed from the pictures.

An operator of the flow line server 22 checks, through the pictures taken by the camera, the shopping pattern of a customer whose route is specified by the flow line. Then, when the merchandise data on a first item purchased by the customer is input to a POS terminal at a checkout point, the operator operates an input section to input the terminal number of the POS terminal 11. Upon this operation, the time and date (i.e., transaction time and date) and terminal number at the time are added to the flow line data of the customer. Consequently, as shown in FIG. 3, the flow line database 24 stores a record 24R in which the terminal number and the transaction time and date are added to the flow line ID and flow line data (i.e., time and date per unit time and the positional coordinates) of the customer specified by this ID.

The customer shopping pattern analysis apparatus 3 includes a computer equipment such as a personal computer. Specifically, the customer shopping pattern analysis apparatus 3 has an input section 31, display section 32, a communication section 33, program storage section 34, data storage section 35, output file 36, and control section 37, etc. The input section 31 including input devices such as a keyboard and mouse is used to input data required to analyze the shopping pattern of each customer. The display section 32 including, for example, a liquid crystal display, displays the result of the analysis of each customer shopping pattern. The communication section 33 performs data communication with the POS server 12 and the flow line server 22.

The program storage section 34 including read-only memory (ROM) stores various program data. The data storage section 35 composed of random access memory (RAM) holds various data tables. Recorded in an output file 36 composed of a recording medium such as a hard disk or optical magnetic disk are data used to analyze the shopping pattern of customers. The control section 37 including a central processing unit (CPU) as its main component controls each of the sections according to programs stored in the program storage section 34 and processes data relating to the analysis of customers' shopping patterns.

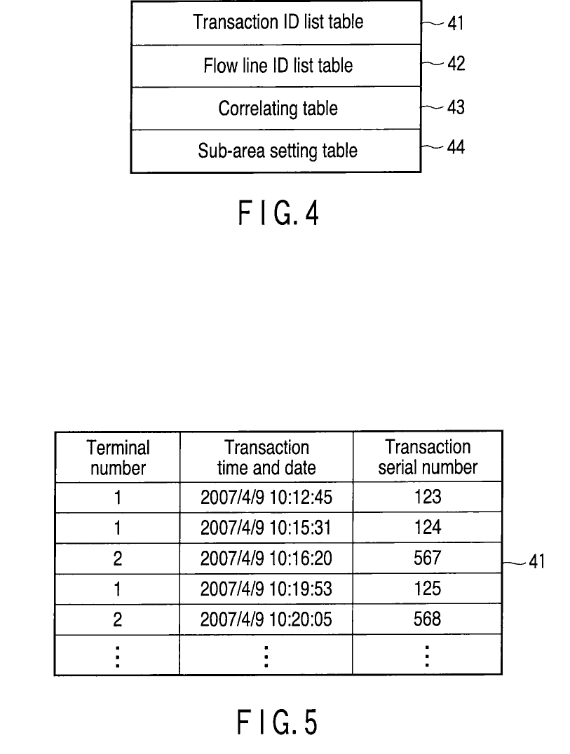

As shown in FIG. 4, the data storage section 35 has a transaction ID list table 41, a flow line ID list table 42, a table 43 correlating the transaction data and flow line data, and a sub-area setting table 44.

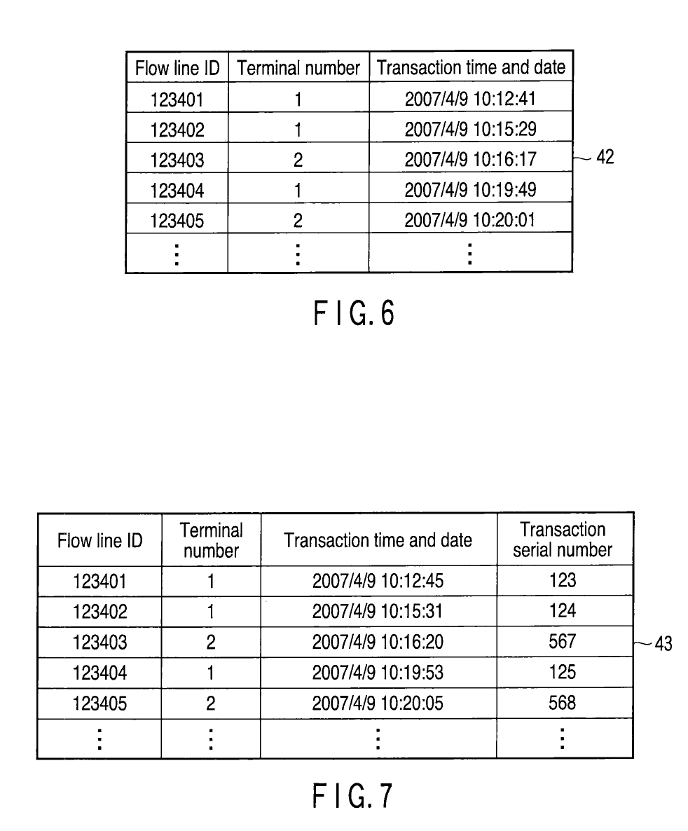

As shown in FIG. 5, the transaction ID list table 41 stores transaction IDs (i.e., terminal numbers, transaction times and dates, and transaction serial numbers) for corresponding transaction data. As shown in FIG. 6, the flow line list table 42 stores the flow line ID, the terminal number, and the transaction date and time added to each of the flow line data. For each flow line ID stored in the flow line ID list table 42, the correlating table 43 stores, as shown in FIG. 7, the transaction ID of the transaction data correlated with the corresponding flow line data specified by the flow line ID.

The program correlating the transaction data and the flow line data are stored in the program storage section 34. Upon the start of the correlating program, the control section 37 carries out the process described below.

First, the control section 37 receives an input regarding a correlating target period. Upon input of the correlating target period through the input section 31, the control section 37 extracts from the transaction database 14 of the POS server 12 transaction IDs (i.e., terminal numbers, transaction times and dates, and transaction serial numbers) written in the record 14R, the transaction times and dates of which are within the correlation target period. Then, the transaction IDs are stored in the transaction ID list table 41 in chronological order of transaction.

Subsequently, from the flow line database 24 of the flow line server 22, the control section 37 collects flow line IDs, terminal numbers, and transaction times and dates written in the record 24R, the transaction times and dates of which are within the correlation target period. Then, the collected flow line IDs, terminal numbers, and transaction times and dates are stored in the flow line ID list table 42 in chronological order of transaction.

Next, the control section 37 collates the data of the flow line ID list table 42 and the data of the transaction ID list table 41, and combines data that have identical terminal numbers and the closest transaction times and dates. The control section 37 stores in the correlating table 43 the combinations of the transaction ID and the flow line ID of both data.

In this case, the correlating table 43 functions as a correlating information storage section for storing information that correlates the flow line data and transaction data of an identical customer.

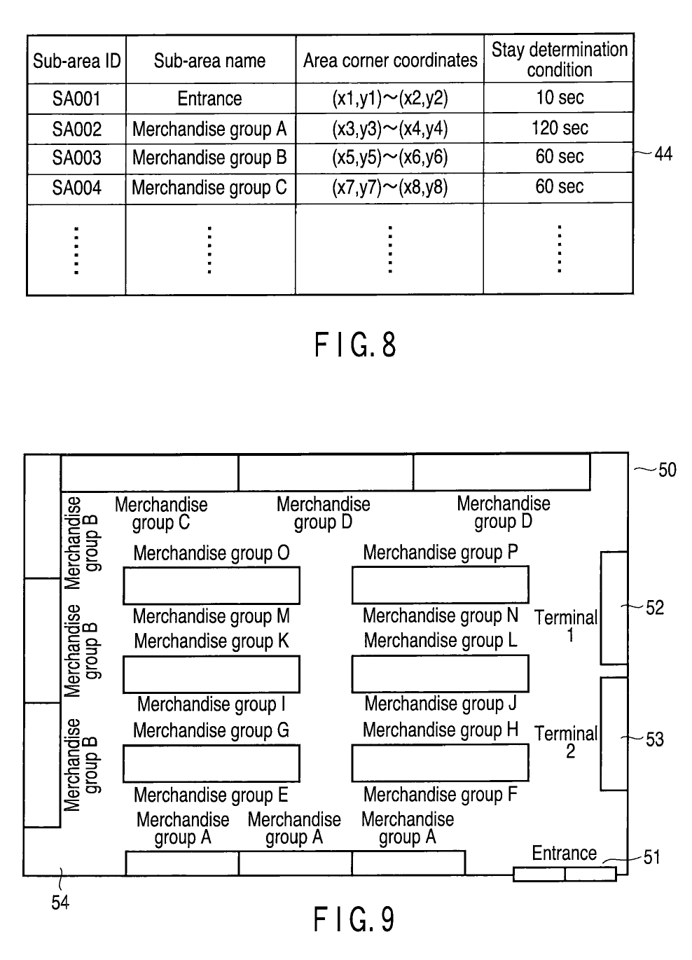

As shown in FIG. 8, a sub-area setting table 44 stores item data (e.g., a sub-area name, area corner coordinates, and conditions for stay determination) corresponding to a unique sub-area ID. Each of areas into which the inside of a shop (i.e., the tracking range of flow line data) is divided is referred to as a sub-area.

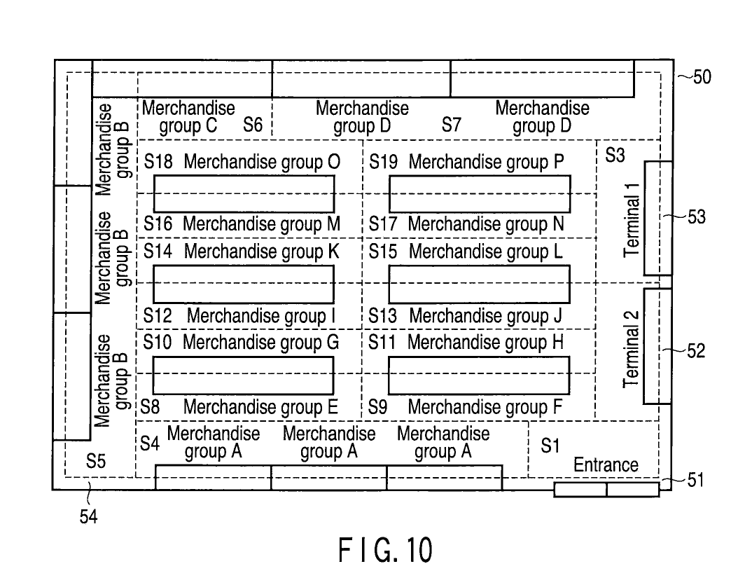

An example of dividing the inside of a shop will now be described with reference to FIGS. 9 and 10. FIG. 9 shows an example of the layout of a shop area 50. The shop area 50 in this example has: an entrance 51 through which customers enter or exit; checkouts 52 and 53 in two places, each checkout being equipped with a POS terminal 11; and a merchandise display section 54 where merchandise is displayed. The merchandise display section 54 is divided according to the merchandise categories (i.e., merchandise groups), such as beverages, lunch boxes, confectionary, magazines, desserts, and stationery. In FIG. 9, merchandise groups in the same category are labeled with the same reference alphabet.

Such a shop area 50 is divided into smaller areas, as shown by broken lines in FIG. 10. Specifically, the entrance 51 and the checkouts 52 and 53 are separated as sub-areas S1, S2, and S3 respectively. The merchandise display section 54 is sectioned according to merchandise categories (i.e., merchandise groups A to P) and labeled with sub-areas S4 to S19. Each of the sub-areas S1 to S19 is rectangular. The two-dimensional coordinates (xi, yi) and (xj, yj) in upper left and lower right corners, respectively, of the rectangle are used as the area corner coordinates of each of the sub-areas S1 to S19.

The condition for stay determination is a threshold for determining whether a customer stayed in any sub-area specified by the corresponding sub-areas ID or just passed by. The present embodiment sets time data for use as the condition for stay determination. If a customer stays in a sub-area corresponding to a flow line for at least the time set as the condition for stay determination, the control section 37 determines that the customer corresponding to the flow line stayed in the sub-area. If a customer leaves a sub-area corresponding to the flow line before the elapse of the set time, the control section 37 determines that the customer corresponding to this flow line just passed the sub-area. A detailed description of such a stay determination means will be given later.

A sub-area setting program used to set the sub-areas is stored in the program storage section 34. The program is initiated by an operator setting the sub-areas.

Upon initiation of the sub-area setting program, the control section 37 displays a flat image of the inside of the shop, as shown in FIG. 9, on the display section 32. The control section 37 waits until rectangles representing sub-areas are drawn on the image. The control section 37 also waits until the names specifying the sub-areas and the corresponding conditions for stay determination are input.

The operator uses an input section 31 to draw rectangles representing sub-areas onto a display image. The operator also inputs the name of each sub-area and the corresponding condition for stay determination. The control section 37 calculates the coordinates (xi, yi) and (xj, yj) in the upper left and lower right corners, respectively, of each rectangular sub-area. Each set of area corner coordinates (xi, yi) and (xj, yj) is stored in the sub-area setting table 44 together with the corresponding input sub-area name and the corresponding condition for stay determination.

The sub-area setting table 44 functions as a sub-area information storage section that stores information specifying the sub-areas into which the inside of the shop is divided, that is, the area corner coordinates. Information specifying the sub-areas is not limited to the area-corner coordinates and it may be replaced by any information that can specify the position of each sub-area.

Upon the division of the shop area 50 into the sub-areas S1 to S19, the customer shopping pattern analysis program run by the customer shopping pattern analysis apparatus 3 becomes effective. This program is stored in the program storage section 34.

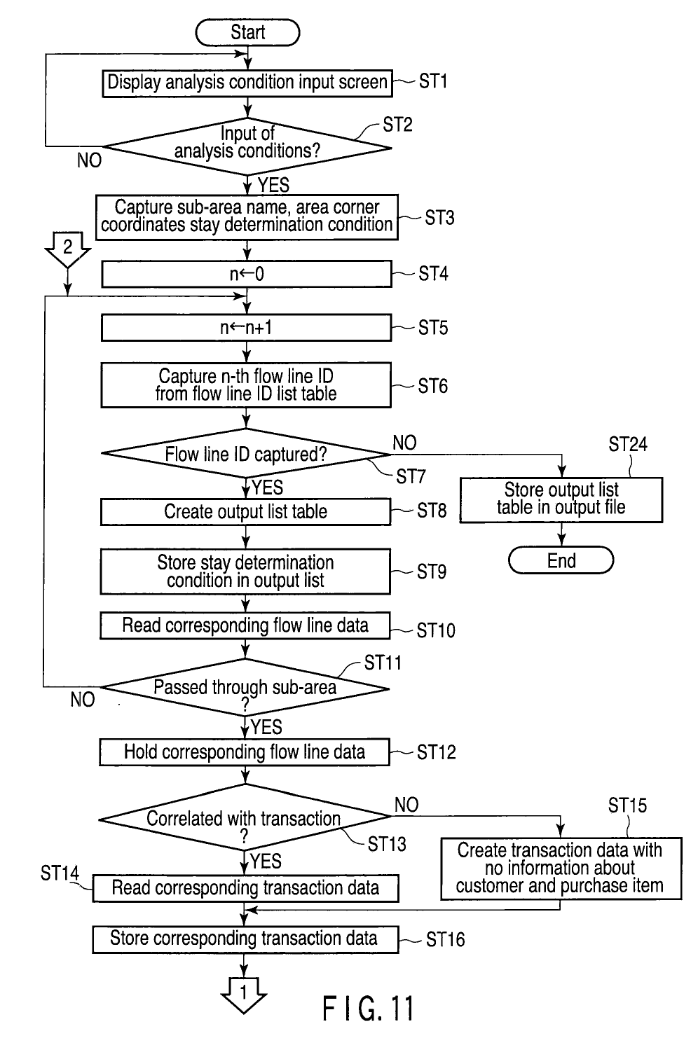

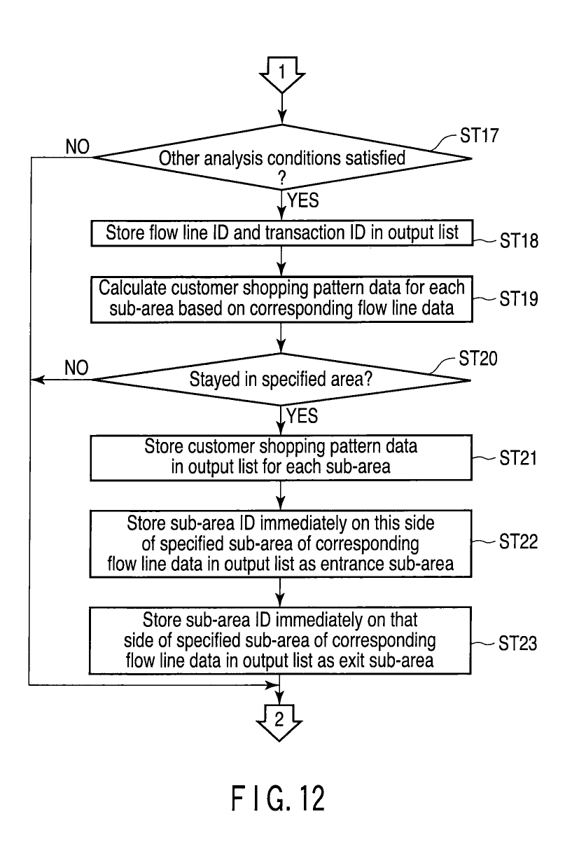

Upon initiation of the customer shopping pattern analysis program, the control section 37 initiates processing as shown in flowcharts in FIGS. 11 to 12. In step ST1, the control section 37 displays on the display section 32 an input screen for analysis conditions. The analysis conditions include items, such as a sub-area ID specifying a sub-area, an item ID or category ID specifying a specific item of merchandise or merchandise group, a transaction period, a transaction time zone, and quality of customer's. Of these items, the input of a sub-area ID is essential and the other items may be input as necessity requires.

It is assumed, as an example, that the apparatus analyzes the shopping patterns of male customers who stayed in a lunch box area from AM 11:00 to PM 1:00 and bought fried chicken lunch boxes during the period from Jul. 1 to Jul. 31, 2007. In this case, the operator inputs, through the input section 31, the sub-area ID of the sub-area name, “magazine,” the item ID of the merchandise name, “fried chicken lunch box,” the transaction period, “20070701 to 20070731,” the transaction time zone, “11:00 to 13:00,” and quality of customer's, “male.”

It is assumed, as another example, that the apparatus analyzes the shopping patterns of customers who purchased any drink in the beverage area after staying in the lunch box area regardless of the transaction period and time zone. In this case, an operator inputs, through the input section 31, the sub-area ID of the sub-area name, “lunch box” and the category ID of the merchandise category, “beverage”. No information about the transaction period, transaction time zone, and quality of customer's is input.

In both the examples, instead of IDs, names may be entered in the items of the sub-areas, merchandise, and merchandise categories.

In step ST2, the control section 37 waits until analysis condition items are input from an analysis condition input screen. If the analysis condition items are input through the input section 31 (YES in ST2), the control section 37 extracts a sub-area ID from the input items. In step ST 3, the control section 37 searches a sub-area setting table 44 in order to capture data (i.e., a sub-area name, area corner coordinates, and a condition for stay determination) corresponding to the sub-area ID.

If the control section 37 captures the data (i.e., a sub-area name, area corner coordinates, and a condition for stay determination) from the sub-area setting table 44, it initializes a counter n to “0” in step ST4. In step ST5, the control section 37 increases the value of the counter n by the amount, “1”.

Each time the value of the counter n increases, the control section 37 performs the process described below. In step ST6, the control section 37 searches a flow line ID list table 42 in order to capture a flow line ID stored in a table number n (n represents the value of the counter n).

In step ST7, the control section 37 determines whether or not the flow line ID with the table number n has been captured from the flow line ID list table 42. If it has been captured (YES in ST7), the control section 37 creates an output list table 60 in the data storage section 35 in step ST8.

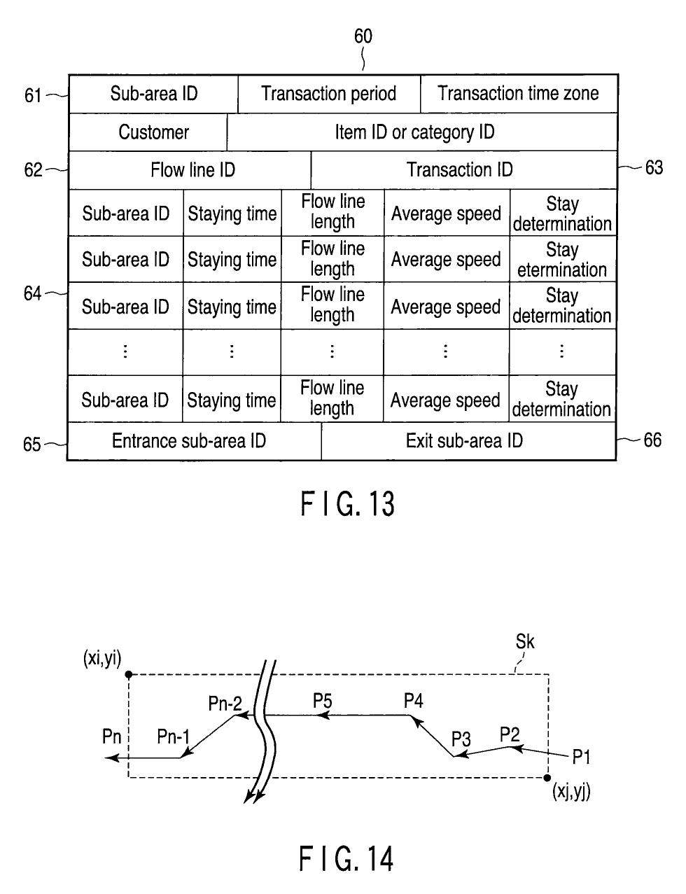

As shown in FIG. 13, the output list table 60 has an analysis condition item area 61, a flow line ID area 62, a transaction ID area 63, a shopping pattern data area 64 for each sub-area, an entrance sub-area ID area 64, and an exit sub-area ID area 65. The analysis condition item area 61 is divided into a sub-area ID area, a transaction period area, a transaction time zone area, a quality of customer's area, and an item ID area or merchandise category ID area. The shopping pattern data area 64 for each sub-area is divided into a staying time area, a flow line length area, an average moving speed area and a stay determination flag area, all of which are available for the sub-area ID of each of the sub-areas S1 to S19.

If the output list table 60 is formed, the control section 37 sets data of analysis condition item input in the analysis condition item areas 61 of the output list table 60 through the analysis condition input screen (step ST9).

In step ST 10, the control section 37 accesses the flow line server 22 through the communication section 33 and searches the flow line database 24 in order to read the record 24R of flow line data specified by the flow line ID captured from the flow line ID list table 42.

If the flow line data record 24R is read from the flow line database 24, the control section 37 determines whether a customer corresponding to the flow line data has passed through a specified sub-area or not (step ST11). The specified sub-area is the sub-area defined by the sub-area ID specified as an analysis condition.

The control section 37 captures the area corner coordinates (xi, yi) (xj, yj) of the specified sub-area from the sub-area setting table 44. Then, the control section 37 checks whether the two-dimensional coordinates (x, y) in each of three-dimensional coordinates composing the flow line data include coordinates (xp, yq){i≦p≦j and i≦q≦j} that define the position in a rectangular area defined by the area corner coordinates.

If the two-dimensional coordinates (x, y) mentioned above include no coordinates (xp, yq), the control section 37 determines that the customer corresponding to the flow line data has not passed through the specified sub-area. In this case (NO in ST11), the control section 37 deletes the record 24R from the flow line data.

If it includes any coordinates (xp, yq), the control section 37 determines that the customer corresponding to the flow line data has passed through the specified sub-area. In this case (YES in ST 11), the control section 37 stores the record 24R of the flow line data in the data storage section 35 as a candidate for analysis (step ST12).

If the flow line data determined to be a candidate for analysis is stored in the data storage section 35, the control section 37 searches the correlating table 43 in order to determine whether or not a transaction ID is correlated with the flow line ID of the flow line data (step ST13).

If a transaction ID is correlated with the flow line ID (YES in ST13), the control section 37 accesses the POS server 12 through the communication section 33 and reads from the transaction database 14 the record 14R of the transaction data defined by the transaction ID (step ST14).

If no transaction ID is correlated with the flow line ID (NO in ST13), the control section 37 creates a mock transaction data record 14R (step S15). This mock transaction data record 14R has no data about a transaction number, terminal number, transaction time and date, total amount of payment, payment section, or merchandise purchased. No information is available on quality of customer's, either.

If the transaction data record 14R is read from the transaction database 14 or the mock transaction data record 14R is created, the control section 37 stores this transaction data record 14R into the data storage section 35 as a candidate for analysis (step ST16).

Next, in step ST17, the control section 37 determines whether or not the flow line data record 24R and transaction data record 14R set as the candidates for analysis satisfy analysis conditions other than sub-area alone.

If an item ID or category ID specifying a particular item of merchandise or merchandise group is specified as an analysis condition, the control section 37 determines whether or not the transaction data record 14R that is the candidate for analysis includes merchandise purchased data that contains the specified item ID or category ID. If it contains this merchandise purchased data, analysis conditions are satisfied. If not, they are not satisfied, in which case, the control section 37 deletes the flow line data record 24R and transaction data record 14R as candidates for analysis.

If at least a transaction period or transaction time zone is specified as an analysis condition, the control section 37 determines whether or not the transaction time and date in the flow line data record 24R set as the candidate for analysis is within the specified transaction period or time zone. If the transaction time and date is within the transaction period or time zone, the analysis conditions are satisfied. If not, the analysis conditions are not satisfied, in which case, the control section 37 deletes the flow line data record 24R and transaction data record 14R as target of analysis.

If quality of customer's is specified as an analysis condition, the control section 37 determines whether or not a category of quality of customer's in the transaction data record 14R that is a target of analysis matches the quality of customer's specified as the condition. If they match, the analysis condition is satisfied. If they do not, the analysis condition is not satisfied, in which case, the control section 37 deletes the flow line data record 24R and transaction data record 14R set as target of analysis.

If the flow line data record 24R and transaction data record 14R as candidates for analysis satisfy none of the analysis conditions other than the sub-area as described above (NO in ST17), the control section 37 deletes the flow line data record 24R and transaction data record 14R.

Conversely, if the flow line data record 24R and transaction data record 14R as candidates for analysis satisfy all specified analysis conditions (YES in ST17), a flow line ID in the flow line data record 24R as a candidate for analysis is set in the flow line ID area 62 of the output list table 60 by the control section 37 (step ST18). In addition, a transaction ID in the transaction data record 14R as a candidate for analysis is set in the transaction ID area 63 of the output list table 60.

In step ST19, based on the flow line data record 24R as candidates for analysis, the control section 37 calculates customers' shopping pattern data, that is, the staying time, flow line length, and average moving speed in each sub-area of each customer corresponding to the flow line data.

Using FIG. 14, next will be described a method for calculating customers' shopping pattern data. FIG. 14 shows an example of data on one flow line of a customer who has passed through a sub-area Sk specified by area corner coordinates (xi, yi) (xj, yj). Each of points P1 to Pn on the flow line data represents the two-dimensional coordinates (xt, yt) of a customer observed at time t (1≦t≦n).

The staying time is the difference between the time t1 at the point P1 immediately before a customer enters a sub-area Sk and the time tn at the first point Pn after the customer exits from the sub-area Sk. That is, the staying time is calculated as [tn−t1].

The moving distance between the two points Pi and Pi+1 on the flow line data is expressed by the following formula (1) when defined by a Euclidean distance function.

Moving distance between the two points Pi and Pi+1 def (distance between P1 and Pi+1)

ex. \sqrt{(xᵢ₊₁−xᵢ)²+(yᵢ₊₁−yᵢ)²} (1)

The flow line length in the sub-area Sk is the sum of the moving distances between the two points observed in the sub-area Sk in time series, and is expressed by the following formula (2)

Flow line length def (all moving distances between each pair of points observed in the shop in time series)

$$= {\sum }_{i = 1}^{n - 1} \overline{{P}_{i} {P}_{i + 1}} = {\sum }_{i = 1}^{n - 1} \sqrt{{( {x}_{i + 1} - {x}_{i} )}^{2} + {( {y}_{i + 1} - {y}_{i} )}^{2}} \qquad ( 2 )$$

The average moving speed in the sub-area Sk is calculated by dividing the flow line length in the sub-area Sk by the staying time, and is expressed by the following formula (3).

Average moving speed def (all moving distances between each pair of points observed in the shop in time series)/(total staying time in the shop)

$$= \frac{{\sum }_{i = 1}^{n - 1} \overline{{P}_{i} {P}_{i + 1}}}{{t}_{n} - {t}_{1}} = \frac{{\sum }_{i = 1}^{n - 1} {\int }_{{t}_{i}}^{{t}_{i + 1}} {v}_{i , i + 1} \cdot Δ {t}_{i , i + 1} d t}{{t}_{n} - {t}_{1}} = \qquad ( 3 )$$

The [vi, i+1] of the right term of the above formula (3) represents the moving speed between the two points observed in time series. If the speed v is constant in an interval Δt, the moving speed between the two points is expressed by the following formula (4).

$${v}_{i , i + 1} = \frac{\overline{{P}_{i} {P}_{i + 1}}}{{t}_{i + 1} - {t}_{1}} = \frac{\overline{{P}_{i} {P}_{i + 1}}}{Δ {t}_{i , i + 1}} \qquad ( 4 )$$

Accordingly, the average moving speed in the sub-area Sk is calculated by the following formula (5).

$$\begin{matrix}Average moving speed = \frac{{\sum }_{i = 1}^{n - 1} {\int }_{{t}_{i}}^{{t}_{i - 1}} \frac{\overline{{P}_{i} {P}_{i + 1}}}{Δ {t}_{i , i + 1}} \cdot Δ {t}_{i , i + 1} d t}{{t}_{n} - {t}_{1}} \\ = \frac{{\sum }_{i = 1}^{n - 1} \overline{{P}_{i} {P}_{i + 1}} \cdot ( {t}_{i + 1} - {t}_{i} )}{{t}_{n} - {t}_{1}}\end{matrix} \qquad ( 5 )$$

Upon the customer shopping pattern data (i.e., staying time, flow line length, and average moving speed) in each sub-area being thus calculated, the control section 37 detects customer shopping pattern data in the sub-area specified as the analysis condition (step ST20). Based on the customer shopping pattern data, the control section 37 then determines whether or not the customer stayed in the specified sub-area. Below is an algorithm for this determination.

First, the control section 37 searches the sub-area setting table 44 in order to capture the stay determination condition data stored so as to correspond to the specified sub-area ID. If the stay determination condition data is captured, the control section 37 detects staying time data from customer shopping pattern data in the specified sub-area, and then compares this staying time data and the stay determination condition data.

If the value of the staying time data is greater than that of the stay determination condition data, the control section 37 determines that the customer stayed in the specified sub-area. If the value of the staying time data is less than that of the stay determination condition data, the control section 37 determines that the customer merely passed through the specified sub-area without staying there.

If the determination is made that the customer did not stay in the specified sub-area (NO in ST20), the control section 37 deletes the flow line data record 24R and transaction data record 14R set as candidates for analysis.

If the determination is made that the customer stayed in the specified sub-area (YES in ST20), the customer shopping pattern data already calculated that corresponds to the sub-area is set in the shopping pattern data area 64 (corresponding to the sub-area) of the output list table 60 by the control section 37 (step ST21). The control section 37 makes a stay determination in the manner described above for each of the sub-areas. For the sub-area ID of each sub-area in which it is determined that the customer stayed, a stay determination flag is set to “1.” For the sub-area ID of each sub-area in which it is determined that the customer did not stay, the stay determination flag is reset to “0”.

Next, based on the flow line data record 24R set as a candidate for analysis, the control section 37 specifies a sub-area located immediately on this side of the specified sub-area the customer enters, that is, an entrance sub-area (step ST22). Below is the algorithm for specifying the entrance sub-area.

First, using coordinates defining the position immediately before the entrance of the specified sub-area, the control section 37 searches the sub-area setting table 44. The control section 37 then captures a sub-area ID defined by the area corner coordinates including those coordinates defining the position immediately before the entrance of the specified sub-area. If the sub-area ID is captured, this ID is used as the ID for the entrance sub-area. The control section 37 sets this entrance sub-area ID into the entrance sub-area ID area 65 of the output list table 60.

Similarly, based on the flow line data record as a candidate for analysis, the control section 37 specifies a sub-area located immediately on that side of the specified sub-area from which the customer exits, that is, an exit sub-area (step ST23). Below is the algorithm for specifying the exit sub-area.

First, using coordinates defining the position immediately beyond the exit from the specified sub-area, the control section 37 searches the sub-area setting table 44. The control section 37 then captures a sub-area ID defined by the area corner coordinates including the coordinates defining the position immediately beyond the exit from the specified sub-area. If the sub-area ID is captured, this ID is used as the ID for the exit sub-area. The control section 37 sets this exit sub-area ID into the exit sub-area ID area 66 of the output list table 60.

Thereafter, the control section 37 deletes the flow line data record 24R and transaction data record 14R set as candidates for analysis.

Each time the value of the counter n is increased, the control section 37 repeats the process from step ST6 to step ST23. When a flow line ID corresponding to the table number n cannot be captured from the flow line ID list table 42 (NO in ST7), the control section 37 writes and stores the output list table 60 into the output file 36 (step ST24).

In the present embodiment, at least a sub-area is specified as an analysis condition. By specifying a sub-area, the flow line data of a customer who stayed in the specified sub-area is extracted from flow line data stored in the flow line database 24. If the flow line data of the customer and the transaction data are correlated in the correlating table 43, the transaction ID of the transaction data is specified. Then, an output list table 60 in which the flow line ID and transaction ID of the flow line data and transaction data respectively are set is created and stored in the output file 36.

Accordingly, the flow line data of a customer who stayed in a specified sub-area and the transaction data of that customer can be specified from the contents of each of the output list tables 60 stored in the output file 36. This makes it easy for an operator to make a detailed analysis of a customer shopping pattern, such as the merchandise purchased by the customer who stayed in a specified sub-area, other areas through which this customer passed, or in which he or she stayed, etc.

The present embodiment allows a particular item of merchandise or merchandise group to be specified as an analysis condition. Upon specifying a particular item of merchandise or merchandise group, the control section 37 creates an output list table 60 that includes a combination of the flow line ID and transaction ID of a customer who, among customers who stayed in a specified sub-area, purchased a specified item of merchandise or merchandise group.

Accordingly, based on the contents of the output list table 60, an operator can narrow down customers to those who stayed in a specified sub-area and purchased a particular item of merchandise or merchandise group, and analyze the shopping pattern of each of these customers in detail.

In the present embodiment, from the flow line data of each customer who stayed in specified sub-areas, the shopping pattern data, i.e., staying time, flow line length, and average moving speed of the customer are calculated for each sub-area where the customer stayed. The shopping pattern data corresponding to each sub-area is set in the output list table 60 corresponding to the customer.

This makes it easy for an operator to make a detailed analysis of the shopping pattern of each customer who stayed in the specified or other sub-areas based on the contents of the output list table 60.

In the present embodiment, from the flow line data of a customer who stayed in a specified sub-area, the control section 37 obtains: an entrance sub-area located immediately on this side of the specified sub-area the customer entered, and an exit sub-area located immediately on that side of the specified sub-area the customer exited. The entrance sub-area and the exit sub-area are set in the output list table 60 corresponding to the customer.

Accordingly, from the contents of the output list table 60, the operator can easily analyze the shopping pattern of a customer in detail such as the area from which the customer entered a specified sub-area where he or she stayed or an area to which the customer came out from this specified sub-area.

Next, an example analysis of a shopping pattern will be described in detail. For example, a customer who stays in the sub-area “lunch box” for three minutes or longer may stay in other sub-areas for a long time before or after buying a lunch box. In such a case, it seems that the customer tarries in other sub-areas with an intention of doing something (e.g., being interested in the merchandise in those sub-areas). Such information might be a hint in helping to induce customers to purchase merchandise in addition to that which they already planned to buy.

Additionally, the shopping patterns of customers who stopped in sub-areas where promotional merchandise is arranged may be categorized as either a type to which particular features are common and a type to which there are no common features. Such information would yield hints to estimating the degree of effectiveness of the merchandise promotion.

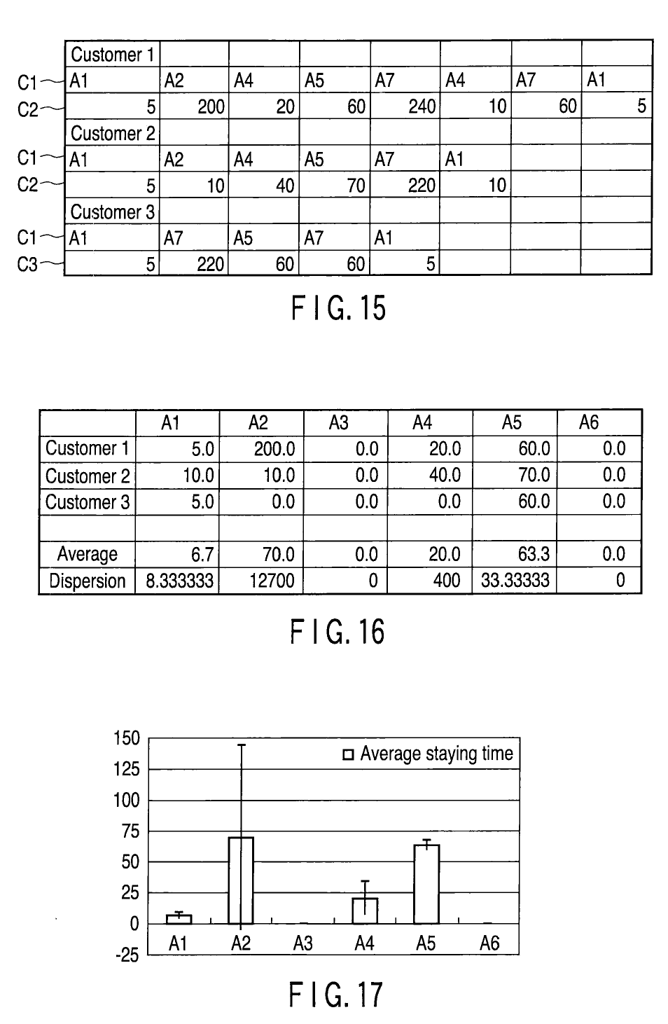

A detailed example will now be given using FIGS. 15, 16, and 17. FIG. 15 shows the flow line data of three customers who stayed in the sub-area “lunch box” (in this example, this sub-area is labeled A7) for three minutes or longer. In FIG. 15, column C1 indicates the names of sub-areas where customer stayed and column C2 indicates staying times.

From their flow line data, the customer shopping pattern analysis apparatus 3 calculates the longest staying times, the average staying times, and the dispersion of staying time in sub-areas other than the sub-area “lunch box” (in this example, A7) set as candidate for analysis. The results are shown in FIG. 16. The graph of the average staying times in those sub-areas is shown in FIG. 17.

Using the average staying time as threshold, the sub-areas are divided into a group of sub-areas where an impulse purchase may occur and a group of other sub-areas. Additionally, these sub-areas are ranked in order of dispersion from the lowest to the highest. This provides information that gives hints to find sub-areas where customers are liable to stay as well as sub-areas where merchandise they plan to purchase has been arranged.

If the threshold of the average staying time is 10 seconds, this applies to the sub-areas A2, A4, and A5. From the order of dispersion, it is found that sub-areas where an impulse purchase seems highly like to occur are A5, A4, and A2, in that order.

In counting them, a variable (initially 0), is assigned to each sub-area for comparison. If the current staying time is found as a result of their comparison to be greater than this variable, the value of the current staying time is stored as a fresh variable for comparison. Thus, the longest staying time for each sub-area is stored as the result of processing.

In the present example, the longest staying time is used as a variable. In fact, the total staying time or the number of times that a sub-area is visited may also be used, and may be defined as functions using them as variables.

Establishing customers' patterns of use for each sub-area provides useful information to investigate the running of shops. In this case, the investigation focuses on, for example, flow line length, staying time and average moving speed. Tendencies to increase or decrease are checked. This makes it possible to find whether a specified area tends to be passed by, or tends to attract many customers as a result of its merchandise arrangement in the area and cause them to stop and think about the merchandise.

Specifically, as shown in [Table 1] below, the increases/decreases in flow line length, staying time, and average moving speed are arranged in eight patterns, and typical examples of how sub-areas are used are classified into six describable patterns.

TABLE 1

| | Flow line | Staying | Average | |
|---|---|---|---|---|
| Pattern | length | time | speed | Use of sub-area |
| 1 | Short | Short | Fast | This area is |
| | | | | used for passage |
| | | | | Merchandise planned |
| | | | | to be purchased |
| | | | | is arranged |
| 2 | Short | Short | Slow | This area is |
| | | | | used for passage but |
| | | | | is difficult to pass |
| 3 | Short | Long | Fast | This area is not used |
| | | | | theoretically |
| 4 | Short | Long | Slow | Merchandise in |
| | | | | this area attracts |
| | | | | customers |
| 5 | Long | Short | Fast | This area is |
| | | | | used for passage |
| | | | | Merchandise planned |
| | | | | to be purchased |
| | | | | is arranged |
| 6 | Long | Short | Slow | This area is |
| | | | | not used |
| | | | | theoretically |
| 7 | Long | Long | Fast | Customer is |
| | | | | walking around |
| | | | | this area |
| 8 | Long | Long | Slow | Customer is |
| | | | | inspecting merchandise |
| | | | | in this area slowly |

For example, where the layout of merchandise is changed in the same sub-area, the operator determines from [Table 1] the tendencies that would be yielded by the layout change. Thereby the operator can estimate the tendency of the use of form of the sub-area by customers.

Where a scheme such as a layout change or point-of-purchase (POP) advertising for particular merchandise is carried out, a group of customers who purchased another item of merchandise belonging to the line of merchandise that includes the particular merchandise is compared with a group of customers (except the customers of the former group) who visited the sub-area. Thus, an operator can find whether or not the shopping patterns of customers who are interested in the line of merchandise have been changed by the scheme.

For example, where a scheme for promoting the sales of particular merchandise is carried out by providing a POP advertisement so that the attractions of the particular merchandise are conspicuous, it is assumed that many of the shopping patterns of customers who purchased the merchandise fall into pattern 1 in [Table 1]. In this pattern, it is presumed that the merchandise has been frequently purchased and almost no time is required for customers to decide to purchase it.

If the scheme affects both the shopping patterns of the group of customers who purchased merchandise of the same line of merchandise as the particular merchandise and those of the other group, the scheme may have effects on customers that go beyond the purpose of making the particular merchandise conspicuous. This would yield useful hints for making the scheme yet more effective.

For example, if the selling area for particular merchandise is expanded to make it more conspicuous and the sub-area where the particular merchandise is displayed has a strong tendency towards the pattern 7 in [Table 1], the following reasons are considered: either a customer is looking for a certain item of merchandise (which was removed due to the expansion of the selling area for the particular merchandise) or the customer is looking for a substitute for the certain item of merchandise.

Such assumptions are the result of combinations of various behaviors of each of the customers in the sub-area because many customers' shopping patterns are considered. Therefore, it is not appropriate to interpret the shopping patterns of many customers in the same manner such that they have the same features. However, where many customers' shopping patterns are collected and the tendencies of their use of each of the sub-areas of a shop is checked in the collection, it is very useful to find tendencies both quantitatively and relatively.

For a sub-area for which the layout change of racks or items of merchandise or the installation of a POP advertisement for particular merchandise is planned, it is important to estimate the routes used by customers to enter or exit this sub-area and their entrance and exit rates.

Where sub-areas visited by customers who stayed in another sub-area are different from one another in terms of entrance and exit rates, there may be a certain relation between the former and latter sub-areas. In particular, if the relation is stable, it is effective to set a POP advertisement in the sub-area where customers stay earlier than the other or to set in a particular sub-area a POP advertisement for an area that is very likely to be visited thereafter.

In this case, in lieu of customers who visit the sub-areas after staying in another sub-area, customers who purchased particular items may be considered. Alternatively, setting the particular items as an AND condition, the customers may be divided into groups to calculate entrance and exit rates.

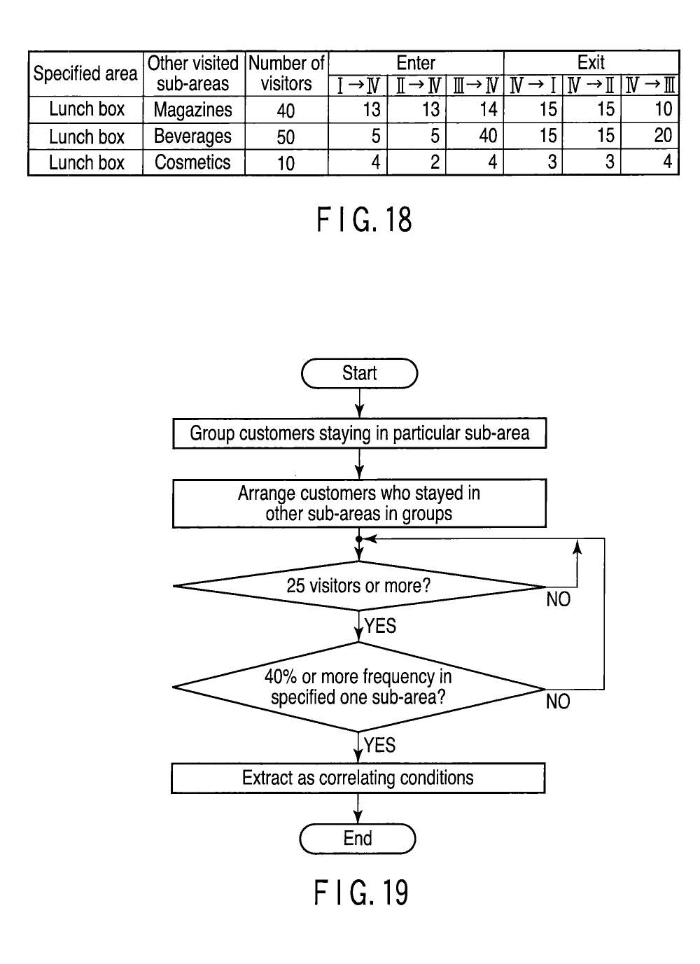

Now, an example is given using a case where the focus is on entrance and exit rates of a lunch box corner. As shown in FIG. 18, if customers who stayed in the lunch box corner visit the sub-areas for magazines, beverages, or cosmetics, an algorithm to find the relation between the number of customers who stay in each of the sub-areas and the entrance and exit rates thereof is illustrated by the flowchart shown in FIG. 19.

Following the steps in the flowchart in FIGS. 11 to 12, the control section 37 first extracts a quantity of each of the flow line data, and the flow line in a particular sub-area (in this example, sub-area “lunch box”) where a customer stayed. From the flow line data, the control section 37 extracts the sub-areas where the customer stayed in addition to the particular sub-area; and then classifies the flow lines for each sub-area. If one flow line indicates two or more sub-areas where the customer stayed, the line may be assigned to only the sub-area where he or she stayed longer or longest or may be assigned to all these sub-areas. Based on whether there are any substantial differences in the number of customers who visited each sub-area and the number of times that customers entered particular paths, the control section 37 determines the relation between a particular sub-area where a customer stayed and substantial differences in the selection of entrance and exit routes.

In the present example, “at least 25 visitors” and “at least 40% as the highest frequency” serve as criteria of significant difference. However, such values change according to the significance of the difference. Accordingly, if there is any substantial difference, it is considered that there is a positive correlation, and the apparatus informs an operator about this.

The present invention is not limited to the foregoing embodiment but may also be embodied by modifying compositional elements without departing from the scope of the invention.

In the embodiment described above, customer shopping pattern data include staying time, and a determination is made based on the staying time whether or not a customer with corresponding flow line data stayed in a specified sub-area. However, the stay determination means is not limited to this and the following means (for example) may be used.

Customer shopping pattern data include flow line length. The threshold of the flow line length is set for each sub-area as a condition for stay determination. The flow line in a specified sub-area and the corresponding threshold are compared. If the flow line length is equal to or greater than the threshold, it is determined that a customer stayed in the sub-area. If the flow line length is below the threshold, it is determined that the customer passed the sub-area by.

Customer shopping pattern data include average moving speed. The threshold of the average moving speed is set for each sub-area as a condition for stay determination. The average moving speed in a specified sub-area and the corresponding threshold are compared. If the average moving speed is below the threshold, a determination is made that a customer stayed in the sub-area. If the average moving speed is equal to or greater than the threshold, a determination is made that the customer passed the sub-area by.

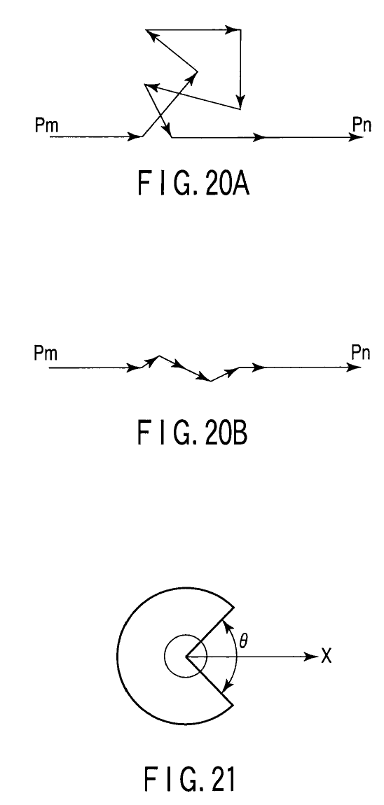

From moving distance per unit time, a determination can be made whether a customer stopped or was walking slowly in a sub-area. A method for the determination will now be described with reference to FIGS. 20 and 21. FIG. 20A shows an example of a flow line when a customer stopped, and FIG. 20B shows an example of a flow line when the customer was walking slowly.

For example, if the movement distance per unit time is equal to or below a threshold and a determination is made from the distance that a customer stopped or was walking slowly, both the flow lines in FIGS. 20A and 20B indicate that a customer stopped or was walking slowly. However, it is difficult to determine only one of these.

To solve the problem, a slow walk determination angle θ is set in the direction X of the latest flow line as shown in FIG. 21. Then, a determination is made whether or not the angle of the direction of the subsequent flow line relative to the direction X of the latest flow line is equal to or smaller than the slow walk determination angle θ. If it is equal to or smaller than the slow walk determination angle θ, a determination is made that the customer is walking slowly. If it is greater than the slow walk determination angle θ, a determination is made that the customer stopped. This makes it possible to determine whether a customer stopped or was walking slowly in a specified sub-area.

In the embodiment described above, the flow line database 24 and the transaction database 14 are disposed outside the customer shopping pattern analysis apparatus 3. However, these databases 14 and 24 may be downloaded to the data storage section of the customer shopping pattern analysis apparatus 3 in advance. This prevents analysis of a customer shopping pattern from affecting the sales management system 1 or flow line management system 2.

In the present embodiment, a description was given of a case where the function of carrying out the present invention, namely, a program for analyzing customers' shopping patterns, is recorded in the program storage section 34 of the apparatus in advance. However, the invention is not limited to this; a similar function may be downloaded from the network to the apparatus, or one that has a similar function stored in a recording medium may be installed in the apparatus. The recording medium may take any form, such as a CD-ROM, as long as it is able to store the program and be readable by the apparatus. The function obtained by such pre-installation or pre-download may be performed in conjunction with the operating system (OS) in the apparatus.

In addition to these, various inventions can be achieved by suitably combining compositional elements disclosed in the embodiments described above. For example, some of the compositional elements disclosed in the embodiments described above may be removed. Furthermore, the compositional elements of these different embodiments may be combined.

The present invention is used to analyze shopping patterns of customers in stores such as a convenience store or a supermarket from the flow line data and transaction data of an identical customer.

What is claimed is:

1. A customer shopping pattern analysis apparatus that analyzes a customer's shopping pattern in a shop based on flow line data, which is data tracing the customer's movement through the shop, and based on the customer's transaction data, the apparatus comprising:
a correlating information storage section configured to store information that correlates flow line data and transaction data acquired from an identical customer;
a sub-area information storage section configured to store information specifying each of sub-areas into which an inner part of the shop is divided;
an analysis condition receiving section configured to receive specifications of at least the sub-areas as analysis conditions;
an analysis target's flow line extracting section configured such that upon receiving specifications of a particular sub-area through the analysis condition receiving section, flow line data of customers who passed through the particular sub-area are extracted based on information specifying the particular sub-area in the sub-area information storage section and based on the flow line data of each of the customers;
a transaction data specification section configured such that transaction data correlated with the flow line data extracted by the analysis target's flow line extracting section is specified with reference to data in the correlating information storage section; and
an analysis target information creating section configured to create information about correlations between the flow line data extracted by the analysis target's flow line extracting section and the transaction data specified by the transaction data specification section.

2. The customer shopping pattern analysis apparatus according to claim 1, wherein the analysis condition receiving section receives additional specifications of a particular item of merchandise or merchandise group, wherein the apparatus further comprises a transaction data selecting section configured such that transaction data of a customer who purchased the particular item of merchandise or merchandise group received by the analysis condition receiving section are selected from the transaction data specified by the transaction data specification section, and wherein the analysis target information creating section creates information about correlations between flow line data correlated with the transaction data selected from the flow line data extracted by the analysis target's flow line extracting section and the transaction data selected by the transaction data selecting section.

3. The customer shopping pattern analysis apparatus according to claim 1, further comprising a shopping pattern data calculation section configured such that customer shopping pattern data in each sub-area is calculated based on the flow line data extracted by the analysis target's flow line extracting section, wherein the analysis target information creating section adds the customer shopping pattern data calculated by the shopping pattern data calculation section based on the flow line data extracted by the analysis target's flow line extracting section, to the information about the correlations between the flow line data and the transaction data.

4. The customer shopping pattern analysis apparatus according to claim 3, wherein the customer shopping pattern data is at least one of a staying time, flow line length, and average moving speed in each sub-area.

5. The customer shopping pattern analysis apparatus according to claim 3, wherein the customer shopping pattern data includes a staying time in the specified sub-area, and wherein the apparatus further comprises a stay determination section configured to determine based on the staying time whether or not the customer corresponding to the flow line data extracted by the analysis target's flow line extracting section stayed in the specified sub-area.

6. The customer shopping pattern analysis apparatus according to claim 3, wherein the customer shopping pattern data includes a flow line length in the specified sub-area, and wherein the apparatus further comprises a stay determination section configured to determine based on the flow line length whether or not the customer corresponding to the flow line data extracted by the analysis target's flow line extracting section stayed in the specified sub-area.

7. The customer shopping pattern analysis apparatus according to claim 3, wherein the customer shopping pattern data includes an average moving speed in the specified sub-area, and wherein the apparatus further comprises a stay determination section configured to determine based on the average moving speed whether or not the customer corresponding to the flow line data extracted by the analysis target's flow line extracting section stayed in the specified sub-area.

8. The customer shopping pattern analysis apparatus according to claim 1, wherein, if determining with reference to data in the correlating information storage section that there is no transaction data correlated with the flow line data extracted by the analysis target's flow line extracting section, the transaction data specification section specifies, as transaction data, data indicating that there is no merchandise purchased.

9. The customer shopping pattern analysis apparatus according to claim 1, further comprising an entrance sub-area specification section configured such that an entrance sub-area located immediately on this side of the specified sub-area the customer corresponding to the flow line data enters is specified based on the flow line data extracted by the analysis target's flow line extracting section, wherein the analysis target information creating section adds data on the entrance sub-area specified by the entrance sub-area specification section, to the information about the correlations between the flow line data and the transaction data.

10. The customer shopping pattern analysis apparatus according to claim 1, further comprising an exit sub-area specification section configured such that an exit sub-area located immediately on that side of the specified sub-area from which the customer corresponding to the flow line data exits is specified based on the flow line data extracted by the analysis target's flow line extracting section, wherein the analysis target information creating section adds data on the exit sub-area specified by the exit sub-area specification section, to the information about the correlations between the flow line data and the transaction data.

11. A customer shopping pattern analysis method for analyzing with a computer a customer's shopping pattern in a shop based on flow line data, which is data tracing the customer's movement through the shop, and based on the customer's transaction data, the method comprising:
the step in which a storage section incorporated in the computer stores correlating data for correlating flow line data and transaction data acquired from an identical customer, and also stores sub-area specification data for specifying each of sub-areas into which an inner part of the shop is divided;
the step in which upon receiving specifications of at least the sub-areas as analysis conditions through an input section incorporated in the computer, an analysis target's flow line extracting section incorporated in the computer extracts flow line data of customers who passed through the particular sub-area, based on data specifying the particular sub-area in the storage section and based on corresponding flow line data in the flow line database;
the step in which referring to correlating data in the storage section, a transaction data specification section incorporated in the computer specifies transaction data correlated with the flow line data extracted by the analysis target's flow line extracting section; and
the step in which an analysis target information creating section incorporated in the computer creates information about correlations between the flow line data extracted by the analysis target's flow line extracting section and the transaction data specified by the transaction data specification section.

12. The customer shopping pattern analysis method according to claim 11, wherein upon receiving additional specifications of a particular item of merchandise or merchandise group as an analysis condition through the input section of the computer, the transaction data selecting section incorporated in the computer selects, from the transaction data specified by the transaction specification section, transaction data of a customer who purchased the particular item of merchandise or merchandise group specified as the analysis condition, and wherein the analysis target information creating section creates information about correlations between flow line data correlated with the transaction data selected from the flow line data extracted by the analysis target's flow line extracting section and the transaction data selected by the transaction data selecting section.

13. The customer shopping pattern analysis method according to claim 11, wherein a shopping pattern data calculation section incorporated in the computer calculates customer shopping pattern data in each sub-area based on the flow line data extracted by the analysis target's flow line extracting section, and wherein the analysis target information creating section adds the customer shopping pattern data calculated by the shopping pattern data calculation section based on the flow line data extracted by the analysis target's flow line extracting section, to the information about the correlations between the flow line data and the transaction data.

14. The customer shopping pattern analysis method according to claim 11, wherein an entrance sub-area specification section incorporated in the computer specifies, based on the flow line data extracted by the analysis target's flow line extracting section, an entrance sub-area located immediately on this side of the specified sub-area the customer corresponding to the flow line data enters, and wherein the analysis target information creating section adds data on the entrance sub-area specified by the entrance sub-area specification section, to the information about the correlations between the flow line data and the transaction data.

15. The customer shopping pattern analysis method according to claim 11, wherein an exit sub-area specification section incorporated in the computer specifies, based on the flow line data extracted by the analysis target's flow line extracting section, an exit sub-area located immediately on that side of the specified sub-area from which the customer corresponding to the flow line data exits, and wherein the analysis target information creating section adds data on the exit sub-area specified by the exit sub-area specification section, to the information about the correlations between the flow line data and the transaction data.

16. A customer shopping pattern analysis program that enables a computer, which is capable of accessing a flow line database storing flow line data tracing customer's movement through a shop and a transaction database storing the customer's transaction data, to function as: a storing means for storing, in a storage section in the computer, correlating data for correlating flow line data and transaction data acquired from an identical customer, and also storing sub-area specification data for specifying each of sub-areas into which an inner part of the shop is divided;
an analysis condition receiving means for receiving specifications of at least the sub-areas as an analysis condition;
an analysis target's flow line extracting means functioning such that upon receiving specifications of a particular sub-area through the analysis condition receiving means, flow line data of customers passed through the particular sub-area are extracted from data specifying the particular sub-area in the storage section and from each flow line data in the flow line database;
a transaction data specification means functioning such that transaction data correlated with the flow line data extracted by the analysis target's flow line extracting means is specified with reference to the correlating data in the storage section; and
an analysis target information creating means functioning to create information about correlations between the flow line data extracted by the analysis target's flow line extracting means and the transaction data specified by the transaction data specification means.

17. The customer shopping pattern analysis program according to claim 16, wherein the analysis condition receiving means further includes a means for receiving specifications of a particular item of merchandise or merchandise group and enables the computer to function as a transaction data selecting means functioning such that transaction data of a customer who purchased the particular item of merchandise or merchandise group specified by the analysis condition receiving means is selected from the transaction data specified by the transaction data specification means, and wherein the analysis target information creating means creates information about correlations between flow line data correlated with the transaction data selected from the flow line data extracted by the analysis target's flow line extracting means and the transaction data selected by the transaction data selecting means.

18. The customer shopping pattern analysis program according to claim 16, wherein the computer is enabled to further function as a shopping pattern data calculation means functioning such that customer shopping pattern data in each sub-area is calculated based on the flow line data extracted by the analysis target's flow line extracting means, and wherein the analysis target information creating means adds the customer shopping pattern data calculated by the shopping pattern data calculation means based on the flow line data extracted by the analysis target's flow line extracting means, to the information about the correlations between the flow line data and the transaction data.

19. The customer shopping pattern analysis program according to claim 16, wherein the computer is enabled to further function as an entrance sub-area specification means functioning such that an entrance sub-area located immediately on this side of the specified sub-area the customer corresponding to the flow line data enters is specified based on the flow line data extracted by the analysis target's flow line extracting means, and wherein the analysis target information creating means adds data on the entrance sub-area specified by the entrance sub-area specification means, to the information about the correlations between the flow line data and the transaction data.

20. The customer shopping pattern analysis program according to claim 16, wherein the computer is enabled to further function as an exit sub-area specification means functioning such that an exit sub-area located immediately on that side of the specified sub-area from which the customer corresponding to the flow line data exits is specified based on the flow line data extracted by the analysis target's flow line extracting means, and wherein the analysis target data creating means adds data on the exit sub-area specified by the exit sub-area specification means, to the information about the correlations between the flow line data and the transaction data.
